(19) United States
(12) Patent Application Publication
(10) Pub. No.: US 2010/0251135 A1
(43) Pub. Date: Sep. 30, 2010

(54) GEOLOGICAL AND GEOPHYSICAL, VISUALIZATION AND INTERPRETATION SOFTWARE BOOKMARKS

(75) Inventors: Pradeep Jain, Sugar Land, TX (US); Xinxin Kong, Sugar Land, TX (US)

Correspondence Address: SCHLUMBERGER INFORMATION SOLUTIONS, 5599 SAN FELIPE, SUITE 1700, HOUSTON, TX, 77056-2722, US

(73) Assignee: SCHLULMBERGER TECHNOLOGY CORPORATION, Sugar Land, TX (US)

(21) Appl. No.: 12/437,366

(22) Filed: May 7, 2009

Related U.S. Application Data
(60) Provisional application No. 61/163,950, filed on Mar. 27, 2009.

(51) Int. Cl. G06F 3/048

(52) U.S. Cl. 715/745; 715/838

(57) ABSTRACT

A method for creating a bookmark for geological and geophysical, visualization and interpretation software is described herein. A visualization of seismic or borehole data may be displayed on a computer screen. A request to create the bookmark may be received. The bookmark may represent a state of the displayed visualization and include one or more settings of the GGVI software. The settings may be determined. The bookmark may be created.

### CROSS-REFERENCE TO RELATED APPLICATION

This application claims benefit of U.S. provisional patent application Ser. No. 61/163,950 filed on Mar. 27, 2009, which is herein incorporated by reference.

### BACKGROUND

1. Field of the Invention

Implementations of various techniques described herein generally relate to techniques for bookmarks in geological, geophysical, visualization and interpretation software.

2. Description of the Related Art

The following descriptions and examples do not constitute an admission as prior art by virtue of their inclusion within this section.

Geological and geophysical data is typically interpreted by geologists and geophysicists (users) using specialized software. The geological and geophysical data is typically stored in a database, which may be packaged with the specialized software. The software may, according to user inputs, retrieve data from the database and create visualizations, according to a user's preferences and interpretations. The visualizations may aid in identifying certain attributes within the data that may indicate the presence of hydrocarbons. The process of creating the visualizations may be tedious for the user, involving many steps to achieve a particular state of visualization/interpretation.

### SUMMARY

Described herein are implementations of various techniques for creating a bookmark for geological and geophysical, visualization and interpretation software is described herein. A visualization of seismic or borehole data may be displayed on a computer screen. A request to create the bookmark may be received. The bookmark may represent a state of the displayed visualization and include one or more settings of the GGVI software. The settings may be determined. The bookmark may be created.

Also described herein are implementations of various techniques for restoring the bookmark. A request to restore the bookmark may be received. The bookmark represents a state of a visualization of seismic or borehole data and includes one or more settings of the GGVI software. The bookmark may be retrieved in response to receiving the request. A visualization for the GGVI software may be generated. The visualization may be based on the bookmark. The visualization may be displayed on the computer screen.

Also described herein are a system that includes a memory and a computer processor. The memory contains program instructions executable by the computer processor to create a bookmark, display a visualization of seismic or borehole data on the computer screen using the GGVI software, and receive a request to create the bookmark. The bookmark represents a state of the displayed visualization and include one or more settings of the GGVI software. The memory contains further program instructions executable by the computer processor to determine the settings and create he bookmark.

### BRIEF DESCRIPTION OF THE DRAWINGS

Implementations of various technologies will hereafter be described with reference to the accompanying drawings. It should be understood, however, that the accompanying drawings illustrate only the various implementations described herein and are not meant to limit the scope of various technologies described herein.

FIG. 1 illustrates a system for bookmarks in geological and geophysical, visualization and interpretation (GGVI) software in accordance with implementations described herein.

FIG. 2 illustrates a flow chart of a method for creating a bookmark in the GGVI software in accordance with implementations described herein.

FIG. 3 illustrates a flow chart of a method for restoring a bookmark in the GGVI software in accordance with implementations described herein.

FIG. 4 illustrates a schematic diagram of a computing system in which the various technologies described herein may be incorporated and practiced.

### DETAILED DESCRIPTION

The discussion below is directed to certain specific implementations. It is to be understood that the discussion below is only for the purpose of enabling a person with ordinary skill in the art to make and use any subject matter defined now or later by the patent “claims” found in any issued patent herein.

The following paragraph provides a brief summary of various techniques described herein. In general, a method for creating and restoring bookmarks in geological and geophysical, visualization and interpretation (GGVI) software is described. Geologists and geophysicists (users) may use GGVI software to view and interpret seismic and borehole data about a subsurface of the earth. In the context of the GGVI software, a bookmark may represent a particular save point within a visualization/interpretation that the user may prefer to return to at a later time.

When the user makes a request to create a bookmark, the GGVI software may determine the current data and settings of the save point. The settings may include parameters associated with a current visualization of the seismic/borehole data. The current data and settings may be stored in a database. A bookmark representing the save point may then be created that includes pointers to the current data and settings stored in the database. A thumbnail image representing the bookmark may then be displayed. The user may click on the thumbnail image to restore the bookmark. In one implementation, other representations of the bookmark may be displayed that are configured to restore the bookmark in response to a user selection. For example, the bookmark representation may be character-based, such as a text description of the bookmark.

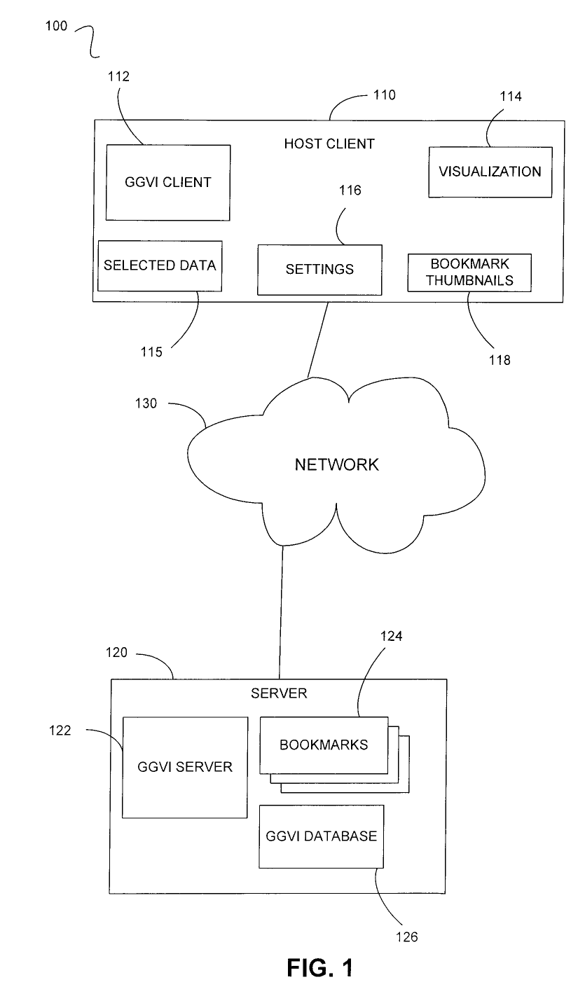

When the user restores the bookmark, the data and settings associated with the bookmark may be retrieved from the database. The GGVI software may re-create the visualizations and restore the data and settings of the bookmark. One or more implementations of those techniques will now be described in more detail with reference to FIGS. 1-4 in the following paragraphs.

FIG. 1 illustrates a system for bookmarks in geological and geophysical, visualization and interpretation (GGVI) software in accordance with implementations described herein. The system may include a host client 110 and a server 120, connected over a network 130. The host client 110 may include a GGVI client 112, a visualization 114, selected data 115, settings 116, and bookmark thumbnails 118.

The GGVI client 112 may accept user inputs to display the visualization 114 of the selected data 115 according to the settings 116. The visualization 114 may represent an image of a subsurface of the earth. The selected data 115 may include seismic and borehole data about the subsurface being visualized. The user may select one or more 2-dimensional (2D) slices or 3-dimensional (3D) regions of the subsurface for the visualization. In one implementation, a GGVI server 122 may retrieve the selected data 115 from a GGVI database 126 on the server 120.

The selected data 115 may also include processed data. For example, the user may use the GGVI software to apply seismic data processes to the selected data 115. Seismic data processes may include areal operations and the like. In one implementation, the GGVI server 122 may perform the seismic data processes in response to requests from the GGVI client 112.

The settings 116 may be specified by user inputs to the GGVI client 112. Settings may include type(s) of data displayed, features displayed, interpretations and other edits, and display preferences.

The types of data may be types of the selected data 115 displayed in the visualization 114. Types of data displayed may include processed data, raw data, and the like. In one implementation, the user may prioritize one type of data over another. For example, the user may specify a preference for displaying processed data rather than raw data. Accordingly, the GGVI client 112 may be configured to display processed data instead of raw data, when both types of data are available.

Features displayed may be geological, geophysical, or survey features that the user selects for display in the visualization 114. For example, features displayed may include wells, boreholes, markers, surface, geological features and the like.

Interpretations and other edits may include annotations to the visualization 114 made by the user. For example, the user may label parts of the visualization 114, such as markers, horizons, faults, and the like. In one implementation, the user may cut and paste portions of the visualization 114 to compare different regions of the subsurface side by side.

Display preferences may include graphic traits of the visualization 114, such as color or color schemes, line thicknesses, zoom factors, text fonts, and the like. The display preferences may also include toolbars used to display and interpret the visualizations 114.

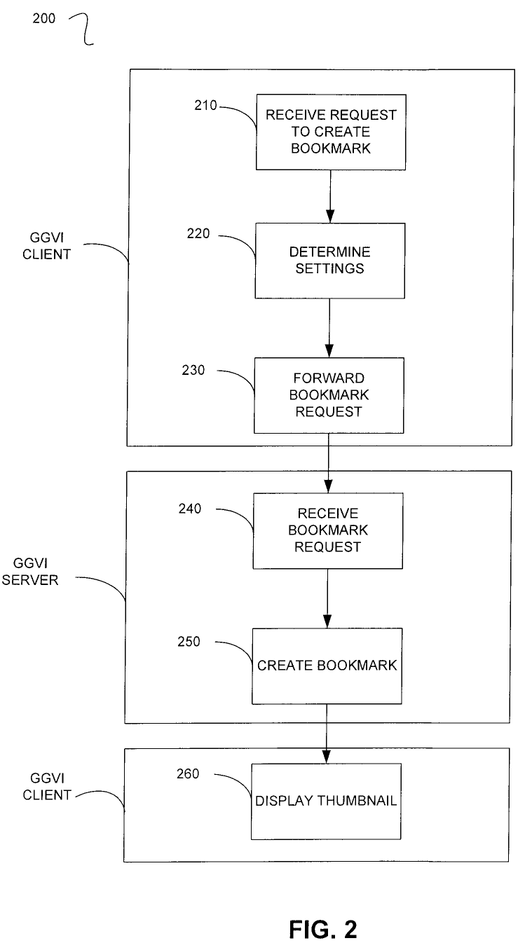

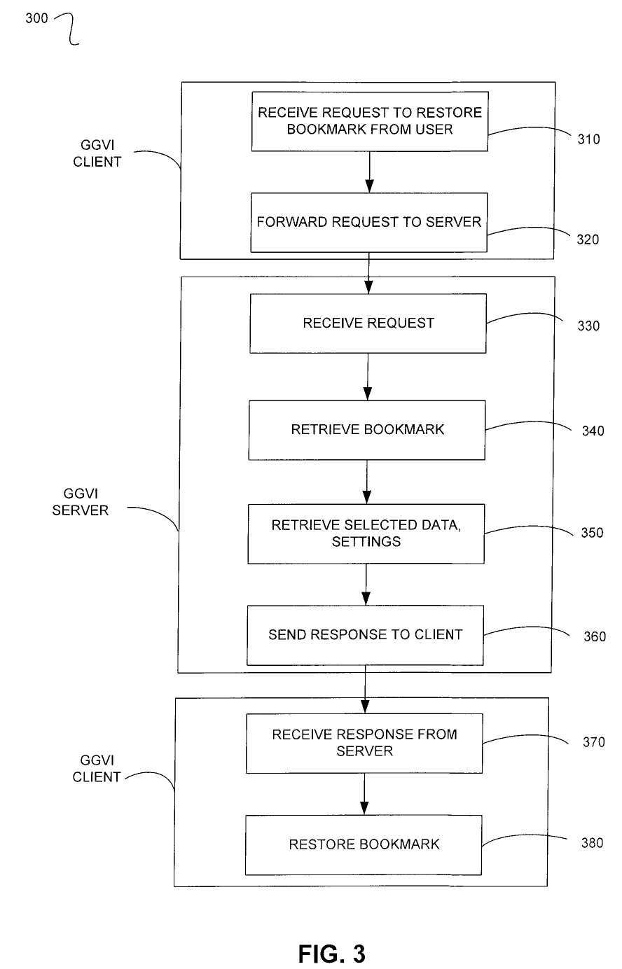

The GGVI client 112 may also accept requests from the user to create and restore bookmarks 124, described in greater detail with reference to FIGS. 2-3. For example, a user may follow a particular workflow when working with the GGVI software. As other priorities arise, the user may stop the workflow and later return to the workflow by restoring a saved bookmark 124. As such, the selected data 115 and settings 116 may be defined by a restored bookmark 124.

Advantageously, creating and restoring bookmarks provides the user a way to return to the stopping point in the workflow without having to repeat the steps that lead to the stopping point. In other words, the user may re-create the visualization 114 without having to re-select features; repeat edits, interpretations, and markings; or, re-define display preferences. Accordingly, the bookmark 124 may be described as a save point during the user's workflow.

In another example, the user may create the bookmark 124 in order to be able to return to a particular point in the workflow. For example, the user may create a bookmark 124 at a save point A. The user may then proceed to make further modifications to the selected data 115 and settings 116. In such a scenario, the user may then restore the bookmark 124 at save point A, which effectively undoes all the modifications after the bookmark 124 at save point A is created.

In one implementation, the bookmarks 124 may be displayed on the host client 110 as bookmark thumbnails 118. In such an implementation, the user may restore one of the bookmarks 124 by clicking on the relevant bookmark thumbnail 118.

It should be understood that the bookmark thumbnails 118 merely represent a directory of the bookmarks 124. Implementations of the various techniques described herein may incorporate alternative directory structures that may be used for displaying and selecting available bookmarks.

The server 120 includes the GGVI server 122, the bookmarks 124, and the GGVI database 126. The GGVI database 126 may contain seismic and borehole data from which the selected data 115 is selected. The GGVI database 126 may also include selected data 115 and settings 116 associated with the bookmarks 124.

The bookmarks 124 may include pointers to associated selected data 115 and settings 116 within the GGVI database 126. In one implementation, the bookmarks 124 may be stored in an extensible markup language (XML) format.

The GGVI server 122 may retrieve the selected data 115 from the GGVI database 126 for the visualization 114 on the host client 110. The GGVI server 122 may also receive requests from the GGVI client 112 to create or restore one of the bookmarks 124. When a request to restore one of the bookmarks 124 is received, the GGVI server 122 may retrieve the selected data 115 and settings 116 associated with the requested bookmark 124 and send a response to the GGVI client 112.

It should be noted that the system architecture of the GGVI client 112, GGVI server 122, and GGVI database 126 in FIG. 1 represents an example of a client-server architecture, although other architectures are possible. For example, implementations of the various techniques described herein might alternately employ a single computer architecture, or other architectures known in the art.

FIG. 2 illustrates a flow chart of a method 200 for creating a bookmark in the GGVI software in accordance with implementations described herein. Method 200 may be performed by the GGVI client 112 and the GGVI server 122. It should be understood that while the flow chart indicates a particular order of execution of the operations, in some implementations, certain steps of method 200 may be executed in a different order.

At step 210, the GGVI client 112 may receive the request to create the bookmark 124. In one implementation, the request may be made by clicking an option in a context menu for the GGVI client 112.

At step 220, the GGVI client 112 may determine the settings 116. Determining the settings 116 may include determining the type(s) of data displayed, features displayed, interpretations and other edits, and display preferences.

At step 230, the GGVI client 112 may forward the create bookmark request to the GGVI server 122. In one implementation, the create bookmark request may include the selected data 115 and settings 116 that are determined at step 220. However, the selected data 115 may be very large. As such, the create bookmark request may alternatively include pointers to the selected data 115 in the GGVI database 126.

At step 240, the GGVI server 122 may receive the bookmark request from the GGVI client 112. At step 250, the GGVI server 122 may create the bookmark 124. In one implementation, the GGVI server 122 may store the selected data 115 and the settings 116 in the GGVI database 126. Accordingly, the bookmark 124 may then be created with pointers to the selected data 115 and the settings 116 in the GGVI database 126.

At step 260, the GGVI client 112 may display the bookmark thumbnail 118 associated with the newly created bookmark. In one implementation, the bookmark thumbnail 118 may be a smaller version of the current visualization 114. In a scenario where the user creates multiple bookmarks 124, multiple bookmark thumbnails 118 may be displayed.

As stated previously, the bookmark thumbnails 118 are merely one example of a directory for the bookmarks 124. Other implementations of directories for the bookmarks 124 may be used in the various techniques described herein.

FIG. 3 illustrates a flow chart of a method 300 for restoring a bookmark in the GGVI software in accordance with implementations described herein. Method 300 may be performed by the GGVI client 112 and the GGVI server 122. It should be understood that while the flow chart indicates a particular order of execution of the operations, in some implementations, certain steps of method 300 may be executed in a different order.

At step 310, the GGVI client 112 may receive a user request to restore a bookmark. As stated previously, the bookmarks may be organized within a directory, such as the bookmark thumbnails 118. In such an implementation, the bookmark thumbnails 118 may be clickable to restore the associated bookmark 124.

At step 320, the GGVI client 112 may forward the restore bookmark request to the GGVI server 122. At step 330, the GGVI server 122 may receive the restore bookmark request.

At step 340, the requested bookmark 124 may be retrieved. The bookmark 124 may identify the bookmark's selected data 115 and settings 116. Due to the amount of data involved, the selected data 115 and settings 116 may be identified with pointers into the GGVI database 126. Accordingly, at step 350, the GGVI server 122 may retrieve the selected data 115 and settings 116 from the GGVI database 126.

At step 360, the GGVI server 122 may send a response to the GGVI client 112. The response may include the selected data 115 and settings 116 for the requested bookmark 124.

At step 370, the GGVI client 112 may receive the response to the bookmark request. At step 380, the GGVI client 112 may restore the bookmark 124. The selected data 115 and settings 116 may be updated to the data included in the response. Additionally, the GGVI client 112 may generate the visualization 114 based on the selected data 115 and settings 116 in the response.

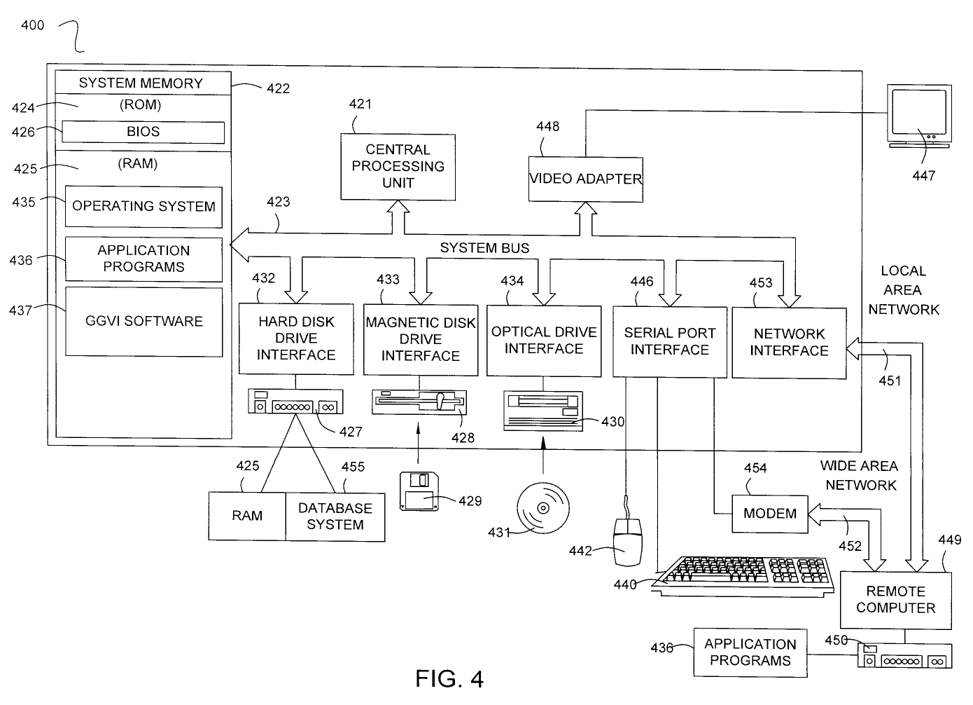

FIG. 4 illustrates a schematic diagram of a computing system 400 in which the various technologies described herein may be incorporated and practiced. The computing system 400 may include a central processing unit (CPU) 421, a system memory 422 and a system bus 423 that couples various system components including the system memory 422 to the CPU 421. Although only one CPU is illustrated in FIG. 4, it should be understood that in some implementations the computing system 400 may include more than one CPU.

The system bus 423 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The system memory 422 may include a read only memory (ROM) 424 and a random access memory (RAM) 425. A basic input/output system (BIOS) 426, containing the basic routines that help transfer information between elements within the computing system 400, such as during start-up, may be stored in the ROM 424.

The computing system 400 may further include a hard disk drive 427 for reading from and writing to a hard disk, a magnetic disk drive 428 for reading from and writing to a removable magnetic disk 429, and an optical disk drive 430 for reading from and writing to a removable optical disk 431, such as a CD ROM or other optical media. The hard disk drive 427, the magnetic disk drive 428, and the optical disk drive 430 may be connected to the system bus 423 by a hard disk drive interface 432, a magnetic disk drive interface 433, and an optical drive interface 434, respectively. The drives and their associated computer-readable media may provide nonvolatile storage of computer-readable instructions, data structures, program modules and other data for the computing system 400.

Although the computing system 400 is described herein as having a hard disk, a removable magnetic disk 429 and a removable optical disk 431, it should be appreciated by those skilled in the art that the computing system 400 may also include other types of computer-readable media that may be accessed by a computer. For example, such computer-readable media may include computer storage media and communication media.

Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 400.

Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. Combinations of the any of the above may also be included within the scope of computer readable media.

A number of modules may be stored on the hard disk 427, magnetic disk 429, optical disk 431, ROM 424 or RAM 425, including an operating system 435, one or more application programs 436, GGVI software 437, and a database system 455. The operating system 435 may be any suitable operating system that may control the operation of a networked personal or server computer, such as Windows® Vista, Mac OS® X, Unix-variants (e.g., Linux® and BSD®), and the like.

The GGVI software 437 may perform all the functionality described herein for the GGVI client 112, and/or the GGVI server 122. In one implementation, the GGVI database 126 may be included in the GGVI software 437. Alternatively, the database system 455 may include the GGVI database 126.

A user may enter commands and information into the computing system 400 through input devices such as a keyboard 440 and pointing device 442. Other input devices may include a microphone, joystick, game pad, satellite dish, scanner, or the like. These and other input devices may be connected to the CPU 421 through a serial port interface 446 coupled to system bus 423, but may be connected by other interfaces, such as a parallel port, game port or a universal serial bus (USB). A monitor 447 or other type of display device may also be connected to system bus 423 via an interface, such as a video adapter 448. In addition to the monitor 447, the computing system 400 may further include other peripheral output devices, such as speakers and printers.

Further, the computing system 400 may operate in a networked environment using logical connections to one or more remote computers, such as a remote computer 449. The remote computer 449 may be another personal computer, a server, a router, a network PC, a peer device or other common network node. Although the remote computer 449 is illustrated as having only a memory storage device 450, the remote computer 449 may include many or all of the elements described above relative to the computing system 400. The logical connections may be any connection that is commonplace in offices, enterprise-wide computer networks, intranets, and the Internet, such as local area network (LAN) 451 and a wide area network (WAN) 452.

When using a LAN networking environment, the computing system 400 may be connected to the local network 451 through a network interface or adapter 453. When used in a WAN networking environment, the computing system 400 may include a modem 454, wireless router or other means for establishing communication over a wide area network 452, such as the Internet. The modem 454, which may be internal or external, may be connected to the system bus 423 via the serial port interface 446. In a networked environment, program modules depicted relative to the computing system 400, or portions thereof, may be stored in a remote memory storage device 450. It will be appreciated that the network connections shown are exemplary and other means of establishing a communications link between the computers may be used.

While the foregoing is directed to embodiments of the present invention, other and further embodiments of the invention may be devised without departing from the basic scope thereof, and the scope thereof is determined by the claims that follow.

What is claimed is:

1. A method for creating a bookmark for geological and geophysical, visualization and interpretation (GGVI) software, comprising:
(a) displaying a visualization of seismic or borehole data on a computer screen;
(b) receiving a request to create the bookmark, wherein the bookmark represents a state of the displayed visualization and includes one or more settings of the GGVI software;
(c) determining the settings; and
(d) creating the bookmark.

2. The method of claim 1, further comprising displaying a representation of the bookmark configured to restore the bookmark in response to a user selection.

3. The method of claim 2, wherein the displayed representation is a thumbnail image.

4. The method of claim 2, wherein the displayed representation is character-based.

5. The method of claim 1, wherein the settings comprise:
one or more types of data to be visualized;
one or more features to be visualized;
annotations by the user;
display preferences; or
combinations thereof.

6. The method of claim 5, wherein the types of data comprise:
raw seismic data;
processed seismic data;
raw borehole data;
processed borehole data; or
combinations thereof.

7. The method of claim 5, wherein the features comprise:
one or more geological features;
one or more geophysical features;
one or more survey features; or
combinations thereof.

8. The method of claim 5, wherein the features comprise:
one or more wells;
one or more boreholes;
one or more markers;
a surface; or
combinations thereof.

9. The method of claim 5, wherein the annotations by the user comprise:
one or more labels of survey markers;
one or more labels of horizons;
one or more labels of faults;
one or more edits that have been made on the visualization; or
combinations thereof.

10. The method of claim 5, wherein the display preferences comprise:
a specified color scheme;
a specified line thickness;
a zoom factor;
a text font; or
combinations thereof.

11. The method of claim 1, further comprising repeating steps a-d for one or more additional bookmarks.

12. The method of claim 11, further comprising maintaining a directory of the bookmark and the additional bookmarks.

13. A method for restoring a bookmark for geological and geophysical, visualization and interpretation (GGVI) software, comprising:
receiving a request to restore the bookmark, wherein the bookmark represents a state of a visualization of seismic or borehole data and includes one or more settings of the GGVI software;
retrieving the bookmark in response to receiving the request;
generating a visualization for the GGVI software based on the bookmark; and
displaying the visualization on a computer screen.

14. The method of claim 13, wherein the request to restore the bookmark comprises receiving a selection of a thumbnail representation of the bookmark.

15. The method of claim 13, wherein the request to restore the bookmark comprises receiving a selection of a character-based representation of the bookmark.

16. The method of claim 13, wherein the settings comprise:
one or more types of data to be visualized;
one or more features to be visualized;
annotations by the user;
display preferences; or
combinations thereof.

17. A system, comprising:
a computer processor; and
a memory comprising program instructions executable by the computer processor to:
display a visualization of seismic or borehole data on a computer screen using a geological and geophysical, visualization and interpretation (GGVI) software;
receive a request to create a bookmark, wherein the bookmark represents a state of the displayed visualization and includes one or more settings of the GGVI software;
determine the settings; and
create the bookmark.

18. The system of claim 17, wherein the memory further comprises program instructions executable by the computer processor to:
receive a request to restore the bookmark;
retrieve the bookmark in response to receiving the request;
generate the visualization for the GGVI software based on the bookmark; and
display the visualization on the computer screen.

19. The system of claim 18, wherein the request to restore the bookmark comprises receiving a selection of a thumbnail representation of the bookmark.

20. The system of claim 18, wherein the request to restore the bookmark comprises receiving a selection of a character-based representation of the bookmark.
